(19) United States
(12) Patent Application Publication
(10) Pub. No.: US 2014/0137920 A1
(43) Pub. Date: May 22, 2014

(54) PHOTOVOLTAIC MODULE

(71) Applicant: Dieter Berg, Frankfurt (DE)

(72) Inventor: Dieter Berg, Frankfurt (DE)

(73) Assignee: ESYZZ UG, BERLIN (DE)

(21) Appl. No.: 14/130,062

(22) PCT Filed: Jun. 19, 2012
(86) PCT No.: PCT/EP2012/061671

§ 371 Date: Dec. 30, 2013

(30) Foreign Application Priority Data
Jun. 29, 2011 (DE) 10 2011 107 365.9

(51) Int. Cl. G01R 31/40

(52) U.S. Cl. CPC H02S 50/00
USPC 136/244

(57) ABSTRACT

A photovoltaic module has at least one solar cell and a socket outlet with voltage outputs of the photovoltaic module. An evaluation and control unit, which detects a voltage and/or a current of the photovoltaic module, is disposed in or on the socket outlet as an assembly. At least one switching element is associated with the photovoltaic module, the switching element being actuable by the evaluation and control unit. The photovoltaic module can be disconnected by the switching element. The evaluation and control unit is configured to detect, based on the detected voltage and/or the detected current, a fault state. The switching element, based on the detected fault state, can be actuated by the evaluation and control unit in order to disconnect or short-circuit at least one of the voltage outputs of the photovoltaic module or the assembly.

The present invention relates to a photovoltaic module according to the definition of the species in claim 1.

Photovoltaic modules include at least one solar cell and one junction box, the junction box having the voltage outputs of the photovoltaic module. The photovoltaic module generally has a plurality of solar cells, which are interconnected in series and/or in parallel as a so-called string, both ends of the string then being routed to the junction box. In the known solar installations, multiple photovoltaic modules may thus also be interconnected as one or more strings.

In the event of dwelling or building fires, the fire department must ensure that the electric power at the scene of action is disconnected so that, for example, the use of extinguishing agents does not result in injuries due to electrocution or arcs.

DE 10 2005 018 173 A1 discloses a method for ensuring the safe interruption of operation of a photovoltaic system using a protection device which is connected to the connectors of the solar installation and which has a bypass for short-circuiting the photovoltaic system. This bypass may be activated manually or automatically. Depending on the size of the photovoltaic system, high currents may flow to the consumers or via the bypass, which must be controlled if the protection device is activated. The protection device must therefore be sized accordingly. The circuitry is designed making full use of semiconductor components. The system is therefore not galvanically isolated from the consumers. The automatic activation occurs via a control line through which the protection device is connected to a remotely situated activation device, so that the system is not isolated in the event of a defective control line.

DE 20 2007 002 077 U1 discloses an emergency disconnection for solar power systems, in which disconnection commands are transmitted via a control line routed from a network connection to a switch box if a disconnection of the network is detected. Here as well, the problem arises that no isolation occurs in the event of a defective control line.

DE 10 2009 022 508 A1 discloses a safety switchgear assembly for a photovoltaic system, wherein the photovoltaic system consists of at least one photovoltaic element, of two connections, each to a feed line leading to a consumer, and the safety switchgear has a bypass which is situated between the two connections and upstream from the at least one switching mechanism and which has at least one switching mechanism to close contact points, wherein at least one additional switching mechanism for opening contact points is situated in each of the two feed lines, wherein the at least one switching mechanism in the bypass and the additional switching mechanisms present in each feed line of the photovoltaic installation are situated, and can be jointly actuated by means of a coupler, in such a way that, when the safety switchgear is actuated, first the contact points of the at least one switching mechanism in each one of the two feed lines are opened and subsequently, with a time delay, the contact points of the at least one switching mechanism, which is situated in the bypass, are closed. The switching mechanism is mechanically actuated by means of a handle or is remotely controlled by means of an actuator which, for example, is formed by an undervoltage actuator which is electrically connected to the in-house network.

DE 10 2008 003 272 A1 discloses a generic photovoltaic module, wherein a function module printed circuit board is situated in a junction box of the photovoltaic module, on which printed circuit board a plurality of function monitoring modules are situated. Such a function monitoring module is an output module, with which the current and voltage of the respective photovoltaic module are monitored in order to obtain information about the function of the photovoltaic module. Monitoring the output is used for documentation and facility design purposes. In addition, the photovoltaic modules are designed with a wired interface or a wireless interface for communicating with a server. Furthermore, it is provided that each individual photovoltaic module of a string may be isolated from the central server in a very simple manner by providing a disconnection module, which is activated by the microprocessor situated on a function module. In the event of fire, it is therefore necessary for each individual photovoltaic module to be disconnected by the server via a corresponding disconnection signal, because the corresponding disconnection command was transmitted by wire or by radio to each individual photovoltaic module.

The technical problem underlying the present invention is to create a photovoltaic module which has a simple design and which ensures safe disconnection if a module is not integrated or connected or in the event of a fault. The technical problem is solved by the subject matter having the features recited in claim 1. Additional advantageous embodiments of the present invention result from the subclaims.

For this purpose, the photovoltaic module comprises at least one solar cell and one junction box, wherein the junction box has the voltage outputs of the photovoltaic module, wherein an evaluation and control unit is situated in or at the junction box, which detects a voltage and/or a current of the photovoltaic module, wherein at least one switching element, which is able to be activated by the evaluation and control unit, is associated with the photovoltaic module, wherein the photovoltaic module is able to be disconnected with the aid of the switching element, wherein the evaluation and control unit is designed in such a way that a fault state is able to be detected with the aid of the detected voltage and/or the detected current and the switching element is able to be activated immediately by the evaluation and control unit based on the detected state, in order to disconnect or short-circuit the at least one of the voltage outputs of the photovoltaic module or the assembly with the aid of the switching element. This makes it possible to detect as well as disconnect the voltage locally at the photovoltaic module itself, so that no communication with a central control unit or any other control center is required. By omitting the communication link, reliability is increased. It should be noted that the fault state also includes states in which the photovoltaic module is not integrated or connected, such as during transport or assembly. The photovoltaic module disconnects itself automatically even in these situations. The disconnection of the photovoltaic module may take place by disconnecting or interrupting a voltage output or by short-circuiting the voltage outputs. In each case, safe contact protection is provided. Based on the fact that the photovoltaic module autonomously performs its own protection, it is possible to integrate the photovoltaic module according to the present invention flexibly with a wide variety of converters. By evaluating the voltage and/or current, it is very simple to detect whether a connected converter is disconnected on the DC or AC side or a short circuit has occurred between the photovoltaic module(s) and the converter or whether the photovoltaic module is even integrated. The evaluation and control unit may be integrated in the junction box or even situated on it as an assembly, so that it is also possible to retrofit existing modules in a very simple manner. In this case, the voltage outputs of the photovoltaic module are routed to the assembly and its voltage output or voltage outputs are disconnected or short-circuited in the event of a fault. However, in both cases, the fault is detected locally at the photovoltaic module and the voltage is disconnected locally and autonomously without a central control unit or control center. It should be noted that the evaluation preferably includes the voltage and current of the photovoltaic module. Furthermore, in addition to the evaluation and control unit, the assembly also preferably includes the at least one switching element.

In an additional specific embodiment, the evaluation and control unit detects and evaluates the magnitude and/or shape of the voltage and/or the current. It is thus possible, for example, to determine an operating point of the photovoltaic module with the aid of the magnitude. For example, if the operating point lies at open circuit or at short circuit, a fault may thus be inferred. The shape, preferably the ripple, may be used to infer whether a converter is connected or not, since its clocking results in a ripple in the current and voltage.

In an additional specific embodiment, a testing device is associated with the evaluation and control unit, with the aid of which a test signal is able to be impressed onto a disconnected voltage output and at least one measurement signal is able to be detected, wherein the evaluation and control unit activates the switching element as a function of the measurement signal. With the aid of the testing device, it is possible to check in the disconnected state whether the photovoltaic module is connected to a converter and/or a fault still exists or has been corrected, the voltage output being able to be switched on if a connected converter or a corrected fault is detected. The photovoltaic module is thus not only able to disconnect itself, but is also able to reconnect itself. It should be noted that the testing device is preferably also a component of the assembly. It should also be noted that the testing device may be fully or partially integrated into the evaluation and control unit.

In an additional specific embodiment, a time-variable test signal is able to be impressed with the aid of the testing device. This allows a better assessment in order, for example, to determine that a disconnected converter is reconnected, but that its input capacitors are already charged, which, for example, is possibly not detectable with a static test voltage.

In an additional specific embodiment, a voltage supply to the evaluation and control unit and/or the testing device is provided by the photovoltaic module. Separate energy stores or voltage supplies are therefore unnecessary. There is thus also no loss in safety, since, if the photovoltaic module generates no voltage, the voltage outputs also do not have to be disconnected. Where applicable, a DC/DC converter or a voltage limiter converts the voltage of the photovoltaic module down to a suitable level of the supply voltage.

In an additional specific embodiment, the switching element is designed as a power relay, with the aid of which galvanic isolation is made possible.

In an additional specific embodiment, all poles of the photovoltaic module or the assembly are able to be disconnected; that is, both voltage outputs are disconnected or interrupted.

In an additional specific embodiment, the switching element is open in the quiescent state; that is, if no supply voltage is present, the voltage output is disconnected. This further increases safety. It may be provided that, if the photovoltaic module again generates voltage, a check is first made via the testing device to determine that no fault exists before the voltage output or voltage outputs are disconnected. This measure also further increases safety. Accordingly, when the photovoltaic module is disconnected via a short circuit of the voltage outputs, the switching element is preferably closed in the quiescent state.

In an additional specific embodiment, a storage element is associated with the evaluation and control unit for providing the supply voltage, in particular in order to ensure a safe run-on in the event of a failure of the voltage of the photovoltaic module and to disconnect itself in an orderly manner.

In an additional specific embodiment, a signaling and/or communication unit is associated with the photovoltaic module, with the aid of which the photovoltaic module signals its state.

The present invention is explained in greater detail below with the aid of preferred exemplary embodiments. The following figures are shown:

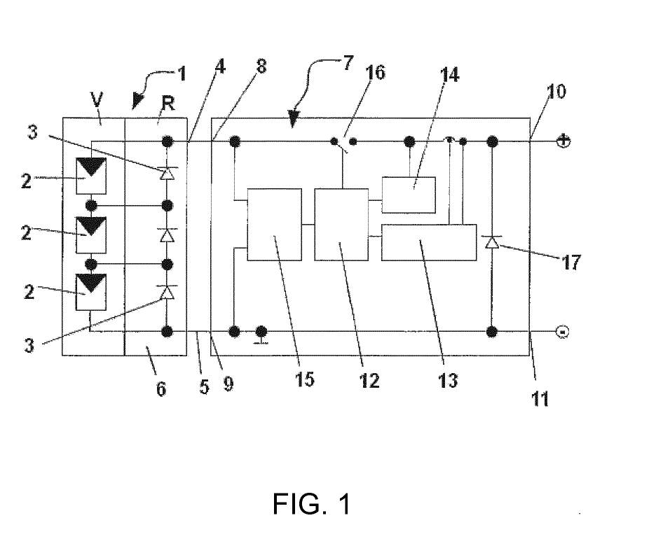

FIG. 1 shows a schematic block diagram of a photovoltaic module having an external assembly;

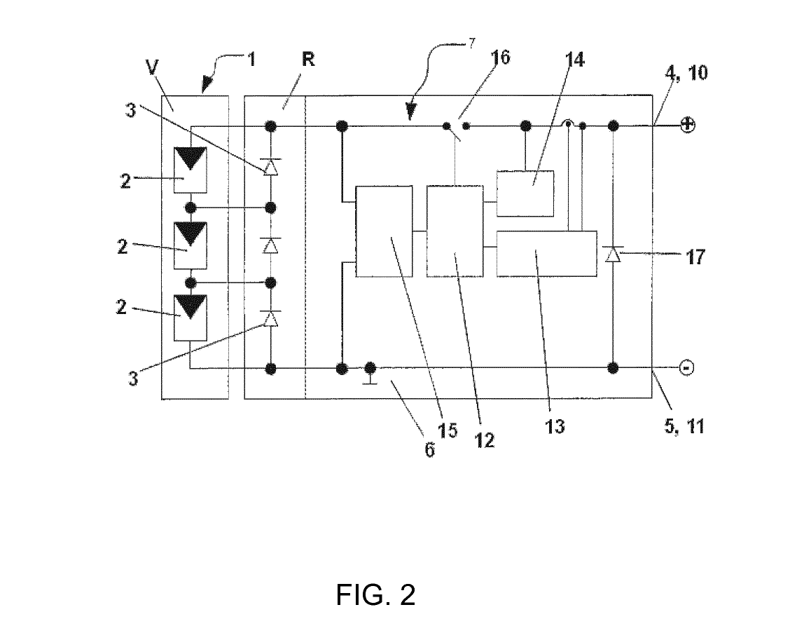

FIG. 2 shows a schematic block diagram of a photovoltaic module having an integrated evaluation and control unit in a junction box of the photovoltaic module;

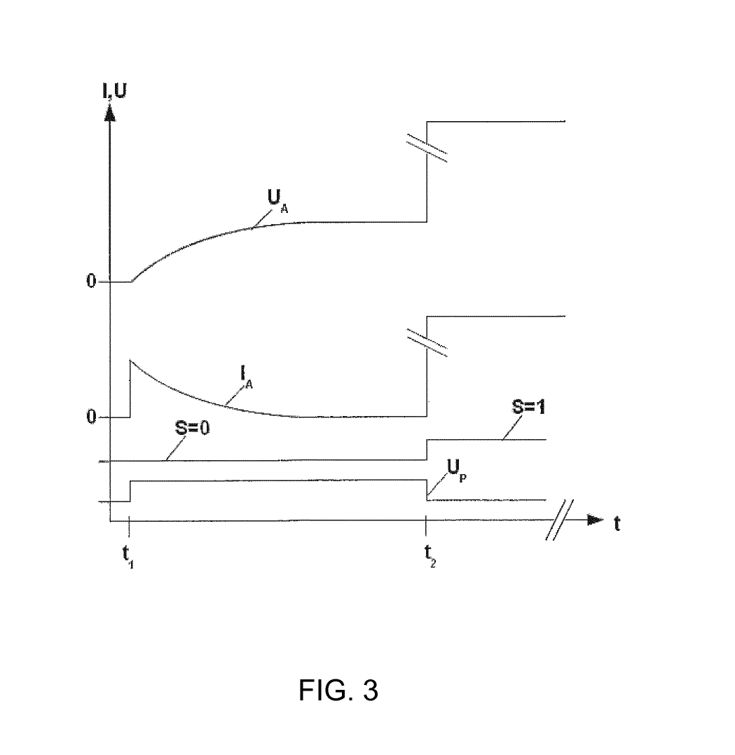

FIG. 3 shows schematic current and voltage curves when checking that the connection to a converter is fault-free in order to connect the photovoltaic module;

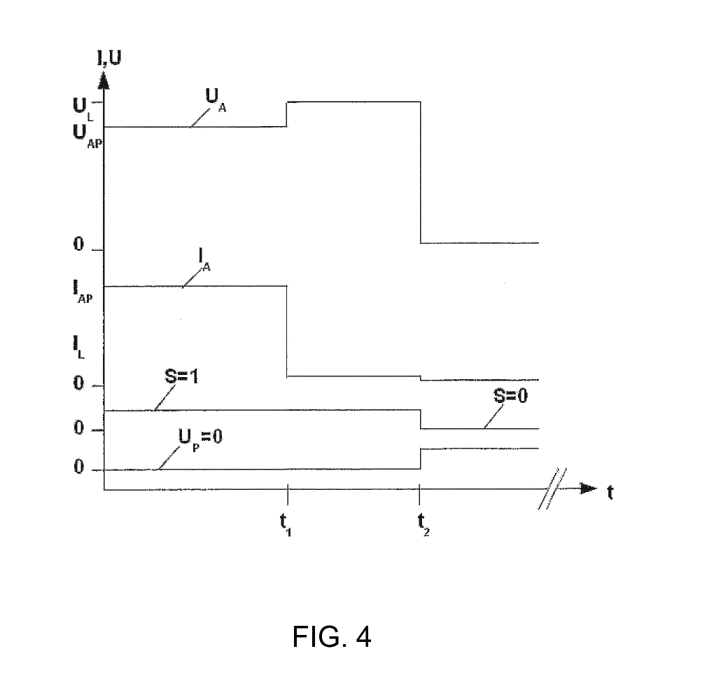

FIG. 4 shows schematic current and voltage curves for a no-load condition;

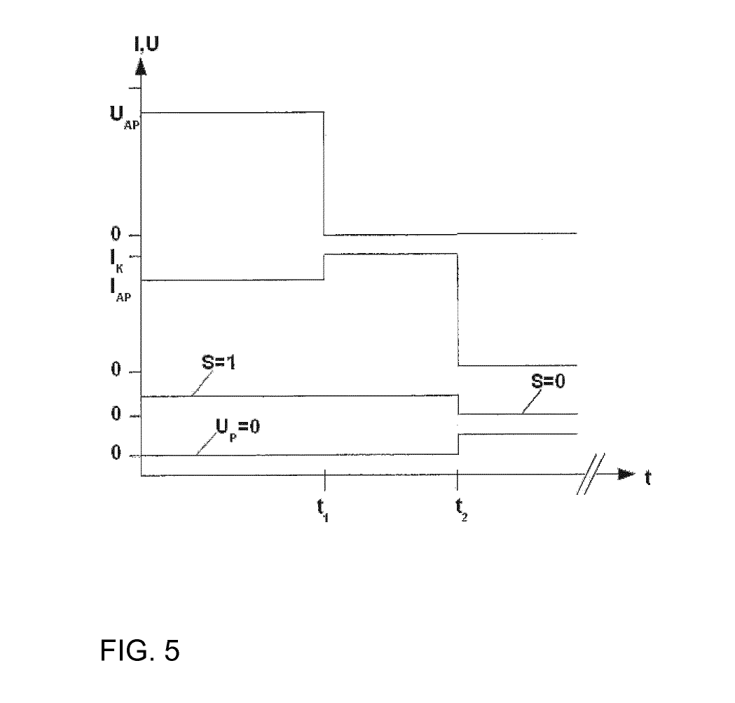

FIG. 5 shows schematic current and voltage curves for a short-circuit condition; and

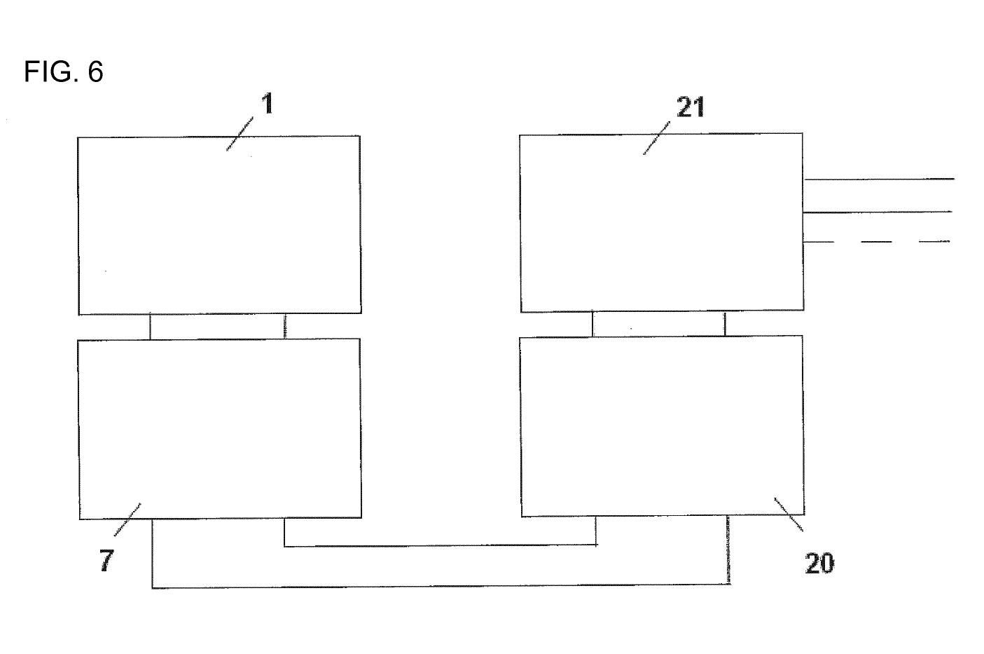

FIG. 6 shows a schematic representation of photovoltaic modules having a converter.

FIG. 1 depicts a first specific embodiment of the present invention. A photovoltaic module 1 is depicted, which has three solar cells 2 on its front side V, which are connected in series as a string. The connections of the solar cells 2 are routed to a rear side R of the photovoltaic module 1, where bypass diodes 3 are situated, which also ensure current flow through the string in the event of the failure of a solar cell 2. Voltage outputs 4, 5 of the photovoltaic module 1 are routed out from the rear side R. The bypass diodes 3 and the voltage outputs 4, 5 are situated in a junction box 6, which is accessible from the rear side R. An assembly 7 is situated locally at the photovoltaic module 1. The assembly 7 includes two voltage inputs 8, 9 and two voltage outputs 10, 11. In addition, the assembly 7 includes an evaluation and control unit 12, a measuring device 13, a testing device 14, an internal voltage supply 15, a switching element 16, and a diode 17. A voltage output 4, 5 of the photovoltaic module 1 is connected to each voltage input 8, 9 of the assembly 7. The at least one switching element 16 lies between the voltage input 8 and the voltage output 10 and is activated by the evaluation and control unit 12. The internal voltage supply 15 is connected to the voltage inputs 8, 9 and is thus supplied directly by the photovoltaic module 1. The internal voltage supply 15 supplies the electronic components with voltage, FIG. 1 depicting only the connection to the evaluation and control unit 12. The measuring device 13 detects the voltage and current at the voltage output 10, 11 of the assembly 7.

FIG. 2 depicts an alternative specific embodiment in which the assembly 7 is integrated into the junction box 6 of the photovoltaic module 1. The voltage outputs 4, 5 are thus identical to the voltage outputs 10, 11 of the assembly 7. Reference may otherwise be made completely to the embodiments in FIG. 1.

Before the method of operation of the photovoltaic module 1 according to the present invention having an internal or external assembly 7 is explained in greater detail with the aid of FIGS. 3 to 5, a portion of a solar installation will be briefly explained in greater detail with the aid of FIG. 6.

There, the photovoltaic module 1 is depicted having an external assembly 7. The voltage outputs 10, 11 of the assembly 7 are connected to a DC disconnector 20, which is connected to a converter 21. The network, which may be designed as a one-phase or multiphase AC voltage network or as a DC voltage network, is at the output of the converter 21. One or more photovoltaic modules 1 or strings of photovoltaic modules 1 may be connected to or disconnected from the converter 21 via the DC disconnector 20. It should be noted that because the photovoltaic modules 1 are able to be individually disconnected according to the present invention, the DC disconnector 20 may technically also be omitted.

FIGS. 3 to 5 will now be explained in greater detail in connection with FIG. 1. It is assumed that the photovoltaic module 1 initially does not generate any voltage, for example, because it is night. Accordingly, the assembly 7 is not supplied with voltage and the switching element 16 is open (S=0). Accordingly, the voltage at the voltage outputs 10, 11 is zero (U_{A}=0). If the photovoltaic module 1 then again generates voltage, the assembly 7 is supplied with voltage, the switching element 16 initially remaining open. The testing device 14 then applies a small test voltage U_{P} of, for example, 2 V to the voltage output 10 at instant t₁. The converter described in FIG. 6 has an input capacitor. Thus, if the DC disconnector 20 is closed and the converter 21 is connected, the input capacitor of the converter 21 is charged via the test voltage. Accordingly, a large output current I_{A} flows initially, which drops exponentially. Accordingly, the voltage U_{A} rises and is finally equal to the test voltage. From the voltage and current curve, measured by the measuring device 13, the evaluation and control unit 12 detects that the converter 21 is connected or not connected. In the first case, the switching element 16 is closed at instant t₂ (S=1). However, without a connected converter, the switching element 16 remains open and the voltage output is thus disconnected. It may be provided that the testing device 14 generates a time-variable test voltage, so that pre-charged capacitors of the converter 21 are detected. If the switching element 16 is closed (S=1), the test voltage U_{P} is disconnected (U_{P}=0).

FIG. 4 depicts a current and voltage curve in which a no-load condition is detected. The photovoltaic module 1 operates at an operating point U_{AP}, I_{AP}. The voltage and current values are monitored by the measuring device 13. At instant t₁, the measuring device 13 then detects that the voltage U_{A} has risen to the no-load voltage U_{L} and the current I_{A} has dropped to I_{L}. This behavior is interpreted by the evaluation and control unit 12 as a no-load condition, which, for example, occurs due to the network having been disconnected at the converter 21. In this case, only a small no-load current I_{L} flows in order to provide a basic power supply to the converter 21. After the evaluation has been completed, the evaluation and control unit 12 opens the switching element 16 (S=0) at instant t₂. The voltage output 10 is thus disconnected and the following applies: U_{A}=I_{A}=0. A test voltage Up is then applied in order to determine whether the network is again connected or the cause of the fault has otherwise been corrected. It should be noted that the test voltage Up does not have to be present continuously, but may also be applied periodically.

FIG. 5 depicts a current and voltage curve in which a short circuit is detected. The photovoltaic module 1 operates at an operating point U_{AP}, I_{AP}. The voltage and current values are monitored by the measuring device 13. At instant t₁, the measuring device 13 then determines that the voltage falls to U_{A}=0 and the current rises simultaneously to I_{K}. This behavior is interpreted by the evaluation and control unit 12 as a short-circuit fault. In reaction, the evaluation and control unit 12 opens the switching element 16 (S=0) at instant t₂, so that the voltage output 10 is disconnected. U_{A}=I_{A}=0 applies. The test voltage U_{P} is then reapplied. It should be noted that U_{P} is very small relative to U_{AP}, so that the resulting voltage and current are negligible, since because of the test voltage U_{P}, U_{A}=I_{A}=0 does not strictly apply.

1-10. (canceled)

11. A photovoltaic module, comprising:
at least one solar cell;
a junction box containing voltage outputs of the photovoltaic module;
an evaluation and control unit disposed, as a component assembly, in or at said junction box, said evaluation and control unit detecting at least one of a voltage or a current of the photovoltaic module;
at least one switching element, connected to and drivable by said evaluation and control unit, said switching element being disposed to selectively disconnect the photovoltaic module;
said evaluation and control unit being configured to detect a fault state by way of at least one of the detected voltage or the detected current; and
said evaluation and control unit selectively activating said switching element based on the detected fault state in order to disconnect or short-circuit at least one of the voltage outputs of the photovoltaic module or the component assembly.

12. The photovoltaic module according to claim 11, wherein said evaluation and control unit is configured to detect and evaluate a magnitude and/or a shape of the voltage and/or the current.

13. The photovoltaic module according to claim 11, which comprises a testing device associated with said evaluation and control unit, said testing device being configured to impress a test signal onto a disconnected voltage output and to detect at least one measurement signal, and wherein said evaluation and control unit activates said switching element as a function of the measurement signal.

14. The photovoltaic module according to claim 13, wherein said testing device is configured to impress a time-variable test signal.

15. The photovoltaic module according to claim 11, wherein the evaluation and control unit and/or the testing device receive a voltage supply from the photovoltaic module.

16. The photovoltaic module according to claim 11, wherein said switching element is a power relay.

17. The photovoltaic module according to claim 11, wherein all poles of the photovoltaic module are capable of disconnection.

18. The photovoltaic module according to claim 11, wherein said switching element is open in a quiescent state.

19. The photovoltaic module according to claim 11, which comprises a storage element associated with said evaluation and control unit for providing the supply voltage.

20. The photovoltaic module according to claim 11, which further comprises a signaling and/or communication unit associated with the photovoltaic module.
